(19) United States
(12) Patent Application Publication
(10) Pub. No.: US 2026/0311182 A1
(43) Pub. Date: Oct. 8, 2026

(54) FRIENDLY FRAUD CLAIM PREVENTION

(71) Applicant: Wells Fargo Bank, N.A., San Francisco, CA (US)

(72) Inventors: Kami J. Hanson, Columbus, MN (US); Ryan Michael Hegland, Lakeville, MN (US)

(21) Appl. No.: 19/170,813

(22) Filed: Apr. 4, 2025

(51) Int. Cl. G06Q 20/40

(52) U.S. Cl. CPC G06Q 20/4016

(57) ABSTRACT

Various embodiments disclosed relate to a method of friendly fraud prevention. The present disclosure includes A method may include processing a purchase request from a consumer with a digital payment method associated with an account holder. The method may include obtaining mobile driver's license information from the consumer at a time of the purchase request. The method may include determining whether the mobile driver's license information matches the account holder, and in response to determining that the mobile driver's license information does not match the account holder, providing a fraud alert on the digital payment method.

### BACKGROUND

Users experiencing a fraud event, loss, or theft of a bank card often face significant delays in obtaining a replacement card. The traditional process involves multiple steps, including contacting the bank, verifying identity through various means, and waiting for the card to be mailed. This process can be particularly inconvenient for users who are traveling or in need of a replacement card. The current method is not only time-consuming but also stressful for users who are left without access to their funds during this period.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of a system on which the method(s) may be implemented in an example.

FIG. 2 is a schematic diagram of a smart wallet that may be used with the method(s) discussed herein in an example.

FIGS. 3A-3B are flow charts of methods of preventing friendly fraud in an example.

FIG. 4 illustrates a block diagram of an example machine upon which one or more examples may be implemented, according to some examples of the present disclosure.

### DETAILED DESCRIPTION

In some aspects, the techniques described herein relate to a method for verifying a purchase request, the method including: processing a purchase request from a consumer with a digital payment method associated with an account holder; obtaining mobile driver's license information from the consumer at the time of the purchase request; determining whether the mobile driver's license information matches the account holder; and in response to determining that the mobile driver's license information does not match the account holder, providing a fraud alert on the digital payment method.

In some aspects, the techniques described herein relate to a method for processing fraud claims, the method including: receiving a fraud claim from a user, the fraud claim related to a claimed transaction on a digital payment method; retrieving stored transaction data associated with the claimed transaction, the stored transaction data including use of a mobile driver's license (mDL); and determining whether the use of the mDL matches authorized cardholder data, and if the mDL does not match, issuing a fraud alert.

In some aspects, the techniques described herein relate to a non-transitory machine-readable medium including instructions for managing digital identity verification, which when executed by a machine in an online system cause the machine to: receive a fraud claim from a user, the fraud claim related to a claimed transaction on a digital payment method; retrieve stored transaction data associated with the claimed transaction, the stored transaction data including use of a mobile driver's license (mDL); and determine whether the use of the mDL matches authorized cardholder data, and if the mDL does not match, issuing a fraud alert.

Discussed herein are a system for preventing illegitimate friendly fraud claims using mobile driver's licenses (mDLs) and biometric authentication. A consumer can provide credit card information, either at an online or brick-and-mortar point of purchase. When the credit card information is provided, the consumer can provide mobile driver's license information, which can be directly linked to the credit card. This information can be automatically provided through a digital wallet, such as a Very Smart Wallet (VSW). Other identifying information, such as biometric information, can also be linked to the credit card.

While this information is not necessarily provided to the merchant, it is linked with the payment method so that the issuer of the payment method can cross-check and verify the identity of the person using the credit card.

The system can record mDL information at the time of purchase, including details like time, location, mDL data, and biometric authentication used. In the event of a fraud claim, a bank can cross-reference the recorded information with the claim to determine its legitimacy. If the mDL data and biometric authentication match the authorized cardholder, the claim can be automatically denied.

In some instances, a bank accepts a fraud claim and refunds a credit card when a parent or friend loans a card to a child or friend. The cardholder claims that while they may have given the friend their card, they did not authorize whatever transaction they are disputing. In some cases, this is a lie-the cardholder is the one that actually made the transaction. This creates a significant problem for banks, as they must process and investigate these claims, which can be time-consuming and costly. Additionally, it undermines the trust in the financial system and can lead to higher costs for all users due to increased fraud prevention measures.

The system can aim to solve the issue of fraudulent claims where cardholders falsely dispute transactions they actually made, which is costly and time-consuming for banks to investigate.

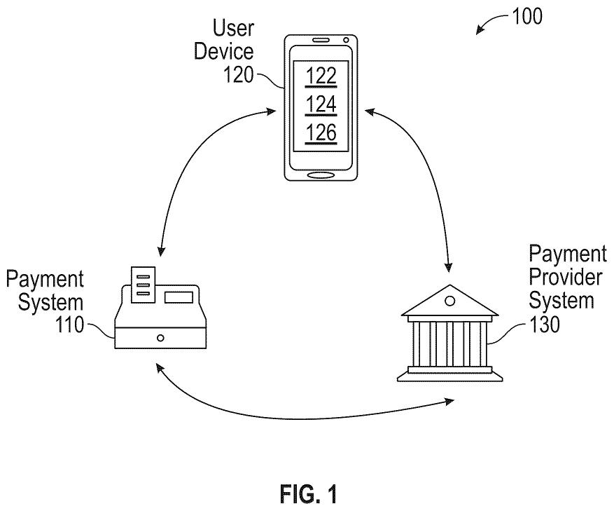

FIG. 1 is a schematic diagram of a system 100 on which the method(s) may be implemented in an example. The system 100 can include a payment system 110, a personal device 120 with a digital wallet 122 including a mobile driver's license (mDL) 124, optionally with one or more biometric verifications 126, and a payment provider system 130.

Here, the payment system 110 can be, for example, a physical check-out system at a store, or an online check-out system. The payment system 110 can be configured to receive a digital payment method from a consumer for a purchase when a purchase request is made. The payment system 110 can be used to accept, for example, payments via credit card, debit card, mobile pay, or other digital methods. The payment system 110 can be configured to receive information from digital wallets. For example, the payment system 110 can be configured to receive information from mDLs. The payment system 110 can optionally be configured to receive one or more biometric verifications, such as a fingerprint for fingerprint recognition or a face for facial recognition. The payment system 110 can be in communication with the payment provider system 130.

The personal device 120 can be, for example, a smartphone or other device with which the consumer intends to pay. The personal device 120 can have, for example, a digital wallet, such as a Very Smart Wallet (VSW) containing one or more payment methods and/or identity credentials, such as a mDL 124. The mDL 124 can be an identity credential such as issued by a governmental entity providing identifying information for a user. Such information can include, for example, name, age, eye color, height, driving restrictions, address, and other bibliographic information.

Optionally, the personal device 120 can include one or more biometric verifications 126. For example, the personal device 120 can verify a user or consumer identity by methods such as facial recognition or fingerprint recognition (e.g., using a captured face or fingerprint of the user). This biometric verification can be used, for example, when a payment method is used from the VSW, when the mDL is used, or both.

The system 100 can further include the payment provider system 130, which can be in communication with the payment system 110 and the personal device 120 when a purchase is requested. The payment system 110 can receive the transaction request, prompt the user to provide the mDL and optionally any biometric data, and then compare the provided information with stored identification information associated with that payment method. In some cases, this can be done automatically. In some cases, the payment provider system 130 can authenticate the user if the captured mDL and/or biometric data is correctly correlated. In this case, the payment provider system 130 can authorize the payment.

Alternatively, the payment provider system 130 can simply collect the provided mDL data at the time of the purchase request, and store this data for future use. For example, if potential fraud is reported, associated with the purchase, the data related to the mDL and/or biometric data can be retrieved for the fraud investigation. In an example, this data retrieval and review can be done automatically, or partially automatically. For this reason, the payment provider system 130 can include the appropriate memory to store this information.

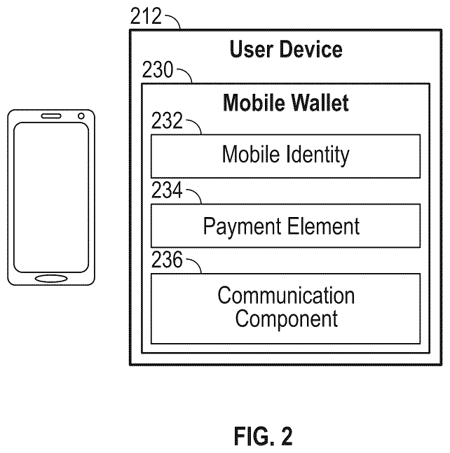

FIG. 2 is a schematic diagram of a user device 212 that may be used with the method(s) discussed herein in an example. The user device 212 can include the mobile wallet 230 with the mobile identity 232, the payment element 234, and the communication component 236.

The user device 212, which contains a mobile wallet 230 with a mobile identity 232, can communicate the mobile identity information, such as mDL information and/or biometric data, to the payment system and/or the payment provider system using the communication component 236. Such information can be used in investigation of friendly fraud claims.

The identity information may be communicated through an mDL communication component scanning an image displayed by a screen of the user device 212 (e.g., a QR or bar code), communicating with the user device 212 using radio frequency technologies such as RFID, Bluetooth, WIFI, or other short range wireless communications technologies (e.g., having a typical usable range of 100 meters or less), or the like.

Once the identity information is received, an identity verification component in the payment provider system can verify the received identity information. This component can, for example, use cryptographic signatures contained within the mobile identity 232 and verifies them using public identifiers (e.g., public keys) stored in a key storage. For example, a public key of an identity credential issuing authority can be used. This can ensure the authenticity of the identity information. The identity information may then be used to access an account of the user or to verify the person using the card for a purchase.

Upon successful identity verification, and upon verifying that the payment card issuing authority has authorized the purchase. It can be further verified that the purchase is being done by an authorized user. The payment provider system 130 can make a determination on a potential fraud alert. This can be communicated with the payment card issuing authority via a server communications component. The mobile payment provisioning may happen using the mDL communication component—e.g., wirelessly.

In an example, keys storage can securely store cryptographic data used for verifying the identity information. These data can be required for the identity verification to authenticate the mobile identity 232 received from the user device 212. The communication component 236 in the user device 212 can facilitate communication with the payment provider system. This component can ensure that the mobile identity and other necessary information are transmitted securely to the payment provider system for fraud investigation. As previously noted, this may include displaying an image, communicating using radio frequency communications, or the like.

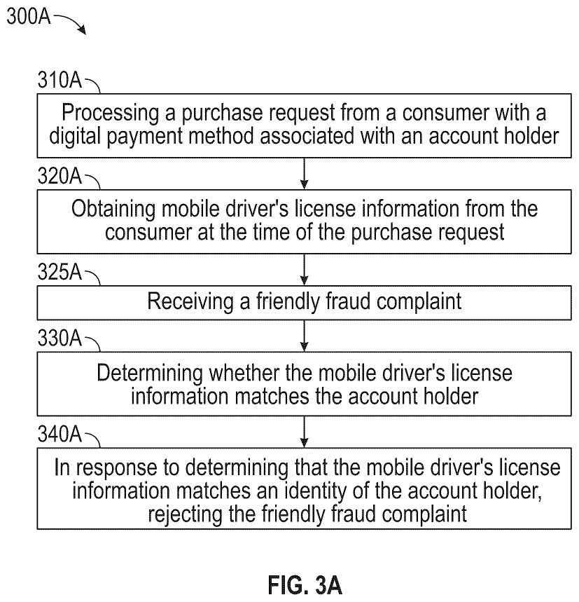

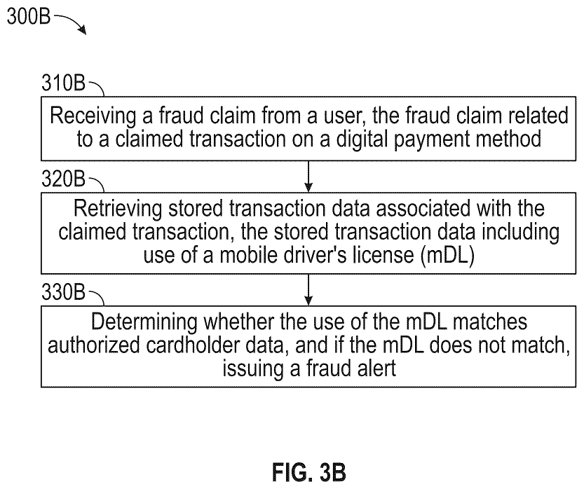

FIGS. 3A-3B are flow charts of methods 300A, 300B of preventing friendly fraud in an example. The methods 300A, 300B can be used to verify a purchase request, and optionally for friendly fraud detection and prevention.

In the method 300A, a purchase request from a consumer with a digital payment method can be processed (block 310A), such as at a payment portal. For example, the purchase request can occur online, or in a store. The purchase request can be from a consumer with a digital payment method, such as a payment method stored in a VSW. The digital payment method can be associated with an account holder or an authorized user.

Next, at block 320A, mobile driver's license information can be obtained from the consumer at the time of the purchase request. In an example, this can include prompting the consumer to authenticate using a mobile driver's license stored in a digital wallet, or prompting the consumer to provide the mobile driver's license information. Block 320A can include prompting the consumer to authenticate the digital payment method using a mobile driver's license stored in a digital wallet.

In some cases, block 320A can include obtaining transaction data at the time of the purchase request, such as a time, a location, an authentication method, or combinations thereof. In some cases, block 320A can include verifying the digital payment method with a biometric identifier at the time of the purchase request. The biometric identifier can include a fingerprint for fingerprint recognition or a face facial recognition. The mobile driver's license information can be transmitted to a provider of the digital payment method for later review.

At block 325A, a friendly fraud complaint can be received. This can be received at a second time subsequent to the time of the purchase request. The complaint can be received by the payment authority. For example, a card holder can submit a fraud alert or request relating to the purchase request.

At block 330A, it can be determined, for example in response to receiving the friendly fraud complaint, whether an identity the mobile driver's license information matches an account holder identity of the account holder. For example, a payment provider system can determine whether a name stored in the mobile driver's license information matches a name of the account holder, such as by doing a string match on text stored, using natural language processing, using a large language model or neural network to compare the information, etc. The information can correspond to the account holder and include identification, age, name, authorized users, or combinations thereof.

At block 340A, in response to determining that the mobile driver's license information matches an identity of the account holder, the friendly fraud complaint may be rejected.

In some cases, the method 300A can be begun after a prompt is received to check for fraud. Subsequently it can be determined whether the mobile driver's license information matches the account holder. The method 300A can include verifying the digital payment method with one or more biometric identifiers of the consumer at the time of the purchase request. The method 300A can include obtaining transaction data at the time of the purchase request, the transaction data at least one of a time of the purchase request, a location of the purchase request, or an authentication method of the purchase request. The method 300A can include transmitting the mobile driver's license information to a provider of the digital payment method, and receiving the identity of the account holder. The method 300A can include prompting the consumer to provide the mobile driver's license information in response to receiving the purchase request.

FIG. 3B depicts method 300B, which can include a method for processing fraud claims. The method can include receiving a fraud claim from a user (block 310B). In an example, the fraud claim can be related to a completed transaction with a payment source.

The method 300B can further include retrieving (e.g., from a database), stored transaction data associated with the completed transaction, the stored transaction data including mobile driver's license (mDL) information (block 320B), such as information that was captured when the completed transaction occurred.

The method 300B can then include determining whether an identity in the mDL information matches an authorized user of the payment source. When identity in the mDL information does not match the authorized user of the payment source, issuing a fraud alert. (Block 330B). The authorized user may include a cardholder, an account holder, a user designated by the cardholder or the account holder as being authorized, or the like. Issuing the fraud alert may include placing a hold on the payment source. Issuing the fraud alert may include refunding a payment corresponding to the completed transaction to the payment source or elsewhere (e.g., back to the account holder in some other channel). The identity in the mDL information can include at least one of a name, a date of birth, a numerical identifier (e.g., an account number, a social security number, an assigned identifier, etc.), or the like. When the identity in the mDL information matches the authorized user, the fraud claim can be denied. In some cases, the confirmation or denial of the fraud claim can be done automatically.

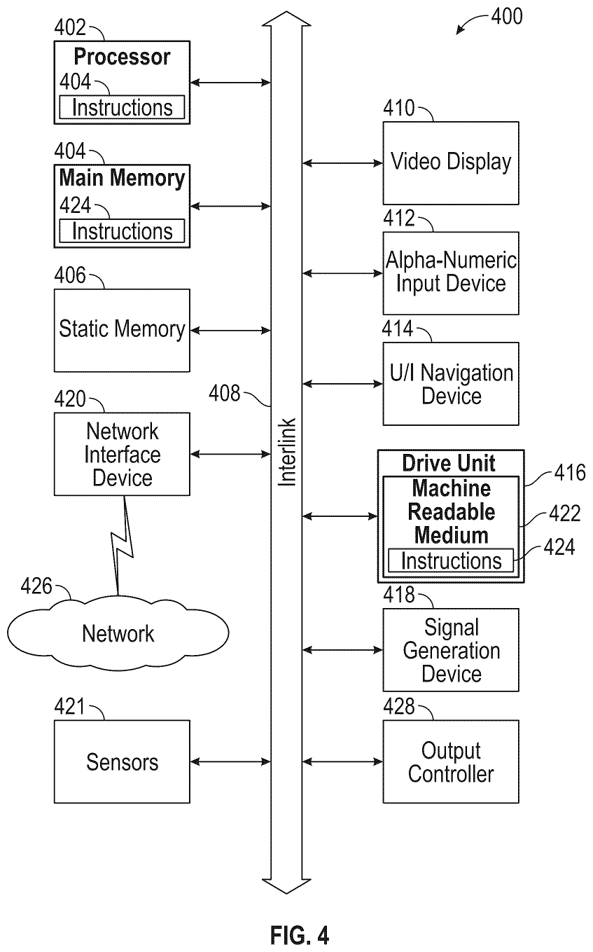

FIG. 4 illustrates a block diagram of an example machine 400 upon which any one or more of the techniques (e.g., methodologies) discussed herein may be performed. In alternative examples, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a desktop computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations. The machine 400 may be configured to be a user device and perform the methods of FIGS. 3A-3B.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or another sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

Each of these non-limiting examples can stand on its own, or can be combined in various permutations or combinations with one or more of the other examples.

Example 1 is at least one non-transitory machine-readable medium comprising instructions for verifying a purchase request, which when executed by processing circuitry, cause the processing circuitry to perform operations comprising: processing the purchase request from a consumer with a digital payment method associated with an account holder; obtaining mobile driver's license information from the consumer at a time of the purchase request; receiving, at a second time subsequent to the time of the purchase request, a friendly fraud complaint from the account holder relating to the purchase request; determining, in response to receiving the friendly fraud complaint, whether an identity in the mobile driver's license information matches an account holder identity of the account holder; and in response to determining that the identity in the mobile driver's license information matches the account holder identity of the account holder, rejecting the friendly fraud complaint.

In Example 2, the subject matter of Example 1 includes, wherein obtaining the mobile driver's license information comprises prompting the consumer to authenticate the digital payment method using a mobile driver's license stored in a digital wallet.

In Example 3, the subject matter of Examples 1-2 includes, verifying the digital payment method with a biometric identifier of the consumer at the time of the purchase request.

In Example 4, the subject matter of Example 3 includes, wherein the biometric identifier comprises a fingerprint for fingerprint recognition or a face for facial recognition.

In Example 5, the subject matter of Examples 1-4 includes, obtaining and saving transaction data at the time of the purchase request, the transaction data including at least one of the time of the purchase request, a location of the purchase request, or an authentication method of the purchase request.

In Example 6, the subject matter of Examples 1-5 includes, wherein determining whether the identity in the mobile driver's license information matches the account holder identity of the account holder comprises verifying information associated with the account holder including at least one of an age or an authorized user of the account holder.

In Example 7, the subject matter of Examples 1-6 includes, transmitting the mobile driver's license information to a provider of the digital payment method, and in response receiving the account holder identity of the account holder.

In Example 8, the subject matter of Examples 1-7 includes, prompting the consumer to provide the mobile driver's license information in response to receiving the purchase request.

In Example 9, the subject matter of Examples 1-8 includes, wherein the purchase request is an online purchase request.

Example 10 is a system for processing fraud Examples, the system comprising: a database; processing circuitry; and memory, including instructions, which when executed by the processing circuitry, cause the processing circuitry to perform operations comprising: receiving a fraud claim from a user, the fraud claim related to a completed transaction with a payment source; retrieving, from the database, stored transaction data associated with the completed transaction, the stored transaction data including mobile driver's license (mDL) information captured when the completed transaction occurred; and determining whether an identity in the mDL information matches an authorized user of the payment source; and in response to determining that the identity in the mDL information does not match the authorized user of the payment source, issuing a fraud alert.

In Example 11, the subject matter of Example 10 includes, wherein issuing the fraud alert includes placing a hold on the payment source.

In Example 12, the subject matter of Examples 10-11 includes, wherein issuing the fraud alert includes refunding a payment corresponding to the completed transaction to the payment source.

In Example 13, the subject matter of Examples 10-12 includes, wherein the identity in the mDL information includes at least one of a name, a date of birth, or a numerical identifier.

Example 14 is a method for verifying a purchase request, the method comprising: processing the purchase request from a consumer with a digital payment method associated with an account holder; obtaining mobile driver's license information from the consumer at a time of the purchase request; receiving, at a second time subsequent to the time of the purchase request, a friendly fraud complaint from the account holder relating to the purchase request; determining, in response to receiving the friendly fraud complaint, whether an identity in the mobile driver's license information matches an account holder identity of the account holder; and in response to determining that the identity in the mobile driver's license information matches the account holder identity of the account holder, rejecting, using processing circuitry, the friendly fraud complaint.

In Example 15, the subject matter of Example 14 includes, wherein obtaining the mobile driver's license information comprises prompting the consumer to authenticate the digital payment method using a mobile driver's license stored in a digital wallet.

In Example 16, the subject matter of Examples 14-15 includes, verifying the digital payment method with a biometric identifier of the consumer at the time of the purchase request.

In Example 17, the subject matter of Example 16 includes, wherein the biometric identifier comprises a fingerprint for fingerprint recognition or a face for facial recognition.

In Example 18, the subject matter of Examples 14-17 includes, obtaining and saving transaction data at the time of the purchase request, the transaction data including at least one of the time of the purchase request, a location of the purchase request, or an authentication method of the purchase request.

In Example 19, the subject matter of Examples 14-18 includes, wherein determining whether the identity in the mobile driver's license information matches the account holder identity of the account holder comprises verifying information associated with the account holder including at least one of an age or an authorized user of the account holder.

In Example 20, the subject matter of Examples 14-19 includes, transmitting the mobile driver's license information to a provider of the digital payment method, and in response receiving the account holder identity of the account holder.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. At least one non-transitory machine-readable medium comprising instructions for verifying a purchase request, which when executed by processing circuitry, cause the processing circuitry to perform operations comprising:
processing the purchase request from a consumer with a digital payment method associated with an account holder;
obtaining mobile driver's license information from the consumer at a time of the purchase request;
receiving, at a second time subsequent to the time of the purchase request, a friendly fraud complaint from the account holder relating to the purchase request;
determining, in response to receiving the friendly fraud complaint, whether an identity in the mobile driver's license information matches an account holder identity of the account holder; and
in response to determining that the identity in the mobile driver's license information matches the account holder identity of the account holder, rejecting the friendly fraud complaint.

2. The at least one non-transitory machine-readable medium of claim 1, wherein obtaining the mobile driver's license information comprises prompting the consumer to authenticate the digital payment method using a mobile driver's license stored in a digital wallet.

3. The at least one non-transitory machine-readable medium of claim 1, further comprising verifying the digital payment method with a biometric identifier of the consumer at the time of the purchase request.

4. The at least one non-transitory machine-readable medium of claim 3, wherein the biometric identifier comprises a fingerprint for fingerprint recognition or a face for facial recognition.

5. The at least one non-transitory machine-readable medium of claim 1, further comprising obtaining and saving transaction data at the time of the purchase request, the transaction data including at least one of the time of the purchase request, a location of the purchase request, or an authentication method of the purchase request.

6. The at least one non-transitory machine-readable medium of claim 1, wherein determining whether the identity in the mobile driver's license information matches the account holder identity of the account holder comprises verifying information associated with the account holder including at least one of an age or an authorized user of the account holder.

7. The at least one non-transitory machine-readable medium of claim 1, further comprising transmitting the mobile driver's license information to a provider of the digital payment method, and in response receiving the account holder identity of the account holder.

8. The at least one non-transitory machine-readable medium of claim 1, further comprising prompting the consumer to provide the mobile driver's license information in response to receiving the purchase request.

9. The at least one non-transitory machine-readable medium of claim 1, wherein the purchase request is an online purchase request.

10. A system for processing fraud claims, the system comprising:
a database;
processing circuitry; and
memory, including instructions, which when executed by the processing circuitry, cause the processing circuitry to perform operations comprising:
receiving a fraud claim from a user, the fraud claim related to a completed transaction with a payment source;
retrieving, from the database, stored transaction data associated with the completed transaction, the stored transaction data including mobile driver's license (mDL) information captured when the completed transaction occurred; and
determining whether an identity in the mDL information matches an authorized user of the payment source; and
in response to determining that the identity in the mDL information does not match the authorized user of the payment source, issuing a fraud alert.

11. The system of claim 10, wherein issuing the fraud alert includes placing a hold on the payment source.

12. The system of claim 10, wherein issuing the fraud alert includes refunding a payment corresponding to the completed transaction to the payment source.

13. The system of claim 10, wherein the identity in the mDL information includes at least one of a name, a date of birth, or a numerical identifier.

14. A method for verifying a purchase request, the method comprising:
processing the purchase request from a consumer with a digital payment method associated with an account holder;
obtaining mobile driver's license information from the consumer at a time of the purchase request;
receiving, at a second time subsequent to the time of the purchase request, a friendly fraud complaint from the account holder relating to the purchase request;
determining, in response to receiving the friendly fraud complaint, whether an identity in the mobile driver's license information matches an account holder identity of the account holder; and
in response to determining that the identity in the mobile driver's license information matches the account holder identity of the account holder, rejecting, using processing circuitry, the friendly fraud complaint.

15. The method of claim 14, wherein obtaining the mobile driver's license information comprises prompting the consumer to authenticate the digital payment method using a mobile driver's license stored in a digital wallet.

16. The method of claim 14, further comprising verifying the digital payment method with a biometric identifier of the consumer at the time of the purchase request.

17. The method of claim 16, wherein the biometric identifier comprises a fingerprint for fingerprint recognition or a face for facial recognition.

18. The method of claim 14, further comprising obtaining and saving transaction data at the time of the purchase request, the transaction data including at least one of the time of the purchase request, a location of the purchase request, or an authentication method of the purchase request.

19. The method of claim 14, wherein determining whether the identity in the mobile driver's license information matches the account holder identity of the account holder comprises verifying information associated with the account holder including at least one of an age or an authorized user of the account holder.

20. The method of claim 14, further comprising transmitting the mobile driver's license information to a provider of the digital payment method, and in response receiving the account holder identity of the account holder.
